(19) United States
(12) Patent Application Publication
(10) Pub. No.: US 2009/0132225 A1
(43) Pub. Date: May 21, 2009

(54) TECHNIQUE FOR CREATING SIMULATED SERVICING APPLICATIONS FROM DATA CAPTURED BY A CONFIGURABLE SOFTWARE PROBE

(75) Inventors: BORNA SAFABAKHSH, MENLO PARK, CA (US); PAUL E. SLAUENWHITE, HAMMOND'S PLAINS (CA); HARM SLUIMAN, SCARBOROUGH (CA)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/940,365

(22) Filed: Nov. 15, 2007

(51) Int. Cl. G06F 9/45

(52) U.S. Cl. 703/22

(57) ABSTRACT

The present invention discloses a system for creating a simulated service application from data captured by a configurable software probe. Such a system can include a servicing application, a configurable software probe, and a simulator generation engine. The servicing application can be configured to provide at least one function to a requesting application. The configurable software probe can be embedded within the servicing application in order to dynamically capture function requests and corresponding return data. The simulator generation engine can be configured to generate a simulated servicing application that simulates a functioning of the servicing application.

### BACKGROUND

1. Field of the Invention

The present invention relates to the field of software development and, more particularly, to creating simulated servicing applications from data captured by a configurable software probe.

2. Description of the Related Art

Computer software is no longer stand-alone programs that operate in a self-contained bubble. The software applications used in today's computing systems must be able to interface with a variety of architectures like a service-oriented architecture (SOA), which requires the software to interact with service applications, and legacy systems. This complexity greatly increases the difficulty to properly test a developed software application with all elements that the application will interact with. Complications also exist for securing, maintaining, and evaluating SOA components in a SOA environment and for ensuring these components interact within acceptable performance boundaries.

It is impractical to create an exact copy of the complex operating environment in order to test the new software application. Attempting to recreate such a system to test a single software application would incur a great cost of equipment and time. For example, implementing a SOA system generally requires a large investment in design time, components, and expertise, such that only large companies with equally large information technology (IT) budgets can afford them.

Adding to the impracticality is the fact that many of the systems that the software application must interact with are under the control of external entities. Thus, the system and/or the applications or software code used by the system is unavailable for use in a testing environment. For example, a company whose database application uses proprietary data structures and software code is not going to provide another company with free access to these proprietary items for testing purposes.

What is needed is a solution that creates a software application that simulates the interactions of a servicing software application to use for software testing. That is, a created simulated servicing application accepts and returns data just as the actual software element without the need for additional infrastructure components. For example, a Web service simulator would provide the typical Web service interactions to the developed software application without the need for a Web server running the service application. Ideally, this solution would create the simulated software application from actual data captured by a configurable software probe embedded within the servicing software application.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for creating a simulated servicing application from data captured by a configurable software probe in accordance with embodiments of the inventive arrangements disclosed herein.

FIG. 2 is a schematic diagram of a simulated servicing application in accordance with an embodiment of the inventive arrangements disclosed herein.

FIG. 3 is a flow chart of a method for creating a simulated servicing application from data captured by a configurable software probe in accordance with an embodiment of the inventive arrangements disclosed herein.

### DETAILED DESCRIPTION OF THE INVENTION

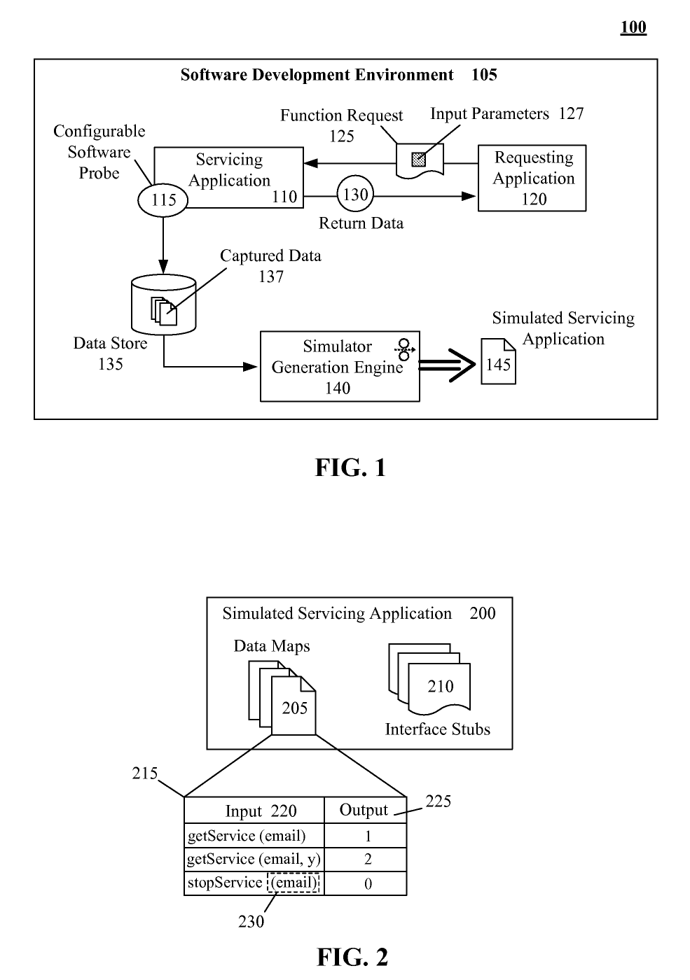

FIG. 1 is a schematic diagram illustrating a system 100 for creating a simulated servicing application 145 from data 137 captured by a configurable software probe 115 in accordance with embodiments of the inventive arrangements disclosed herein. In system 100, a configurable software probe 115 can capture interaction data 125, 127, and 130 between a client application 120 and a servicing application 110. The captured data 137 can then be used by a simulator generation engine 140 to create a simulated servicing application 145 that corresponds to the servicing application 110.

The servicing application 110 can represent a software component of a computing system that responds to a function request 125 from another component, such as the requesting application 120. The requesting application 120 can represent a software component of a computing system that sends function requests 125 to a servicing application 110. An example of such components can be a Web browser and a Web server application.

The servicing application 110 can contain a configurable software probe 115. A configurable software probe 115 can represent a set of software code whose purpose is to monitor a set of user-selected interactions and/or events and capture the data exchanged during those interactions. The configurable software probe 115 can be embedded within the servicing application 110 in a variety of ways, such as during compilation of the servicing application 110 or dynamically at runtime, where both the static and dynamic approaches can use Byte Code Instrumentation (BCI).

In system 100, the configurable software probe 115 can capture the function request 125 sent by the requesting application 120 and the return data 130 generated by the servicing application 110. The function request 125 can represent a message created by the requesting application 120 using standard communication protocols requiring the servicing application 110 to perform a function and send a response. This response can be represented by the return data 130.

The function request 125 can include a set of input parameters 127. The set of input parameters 127 can represent additional data required by the servicing application 110 in order to perform the requested function. For example, input parameters 127 for a security verification service can include parameters for user name and password.

It is important to stress that the use of a configurable software probe 115 to capture data of real interactions of the servicing application 110 is currently not an approach used in the industry or is at least not used in the described context. By capturing actual interaction data, the generated simulated servicing application 145 can simulate interactions based on the actual operation of the servicing application 110.

The configurable software probe 115 can capture the function request 125, input parameters 127, and the corresponding return data 130 for specified interactions between the servicing application 110 and the requesting application 120 and store these items as captured data 137 in an accessible data store 135. When data capture is complete, the simulator generation engine 140 can utilize the captured data 137 to produce a simulated servicing application 145.

In one embodiment, information captured by the software probe 115 can be manipulated or added to. For example, captured information can be sanitized to remove sensitive or confidential information. In another example, heuristics can be used to derive/extrapolate additional input/output data based upon the captured information. In still another example, developers can manually create additional test input/output data based upon the captured information. Regardless of whether system 100 uses direct probe 115 captured information, sanitized data from the probe 115, or a data set derived (automatically or manually) from probe 115 captured information, the resulting data can be referred to as captured data 137 for purposes of system 100.

The simulator generation engine 140 can be a software application designed to generate a simulated servicing application 145 based on interaction data for a specific servicing application 110. The simulated servicing application 145 can represent a software application that simulates the operation of a corresponding servicing application 110 without the internal mechanics and external infrastructure of the corresponding servicing application 110. That is, the simulated servicing application 145 can produce responses that are identical to its corresponding servicing application 110 given the same input.

It should be noted that the simulated servicing application 145 produced by this approach eliminates the need to understand or have access to the inner-workings of the servicing application 110. Some level of access/knowledge of these inner workings may, of course, be needed to instrument the probes 115, which can be optionally handled by a service application 110 owner or agent. That is, the application 110 can be instrumented at design time so that others can simulate its operation without knowing interior details of its workings.

Use of simulated service application 145 can be particularly useful when access to the internal mechanics of the servicing application 110 is unavailable and/or time-consuming to deconstruct. Use of the simulated service application 145 can be especially useful in SOA systems, which inherently abstracts the implementation specifics of software components and that has historically proven difficult to test. For example, many fee-for-use SOA services exist, which are not open source and which do not expose their internal workings. In such a situation, service users, testers, and developers have traditionally had difficulties during integration stages (developing, testing, and maintaining system) of a software effort due to a presence of closed source servicing applications 110. Use of a simulated servicing application 145 generated from captured data 137 resolves many, if not all, of these difficulties.

The components of system 100 can be operated within a software development environment 105. In an alternate embodiment, the servicing application 110, the configurable software probe 115, the requesting application 120, and the interaction data can function in an operational environment (not shown) with the data store 135, simulator generation engine 140, and simulated servicing application 145 remaining in the software development environment 105. Further, the servicing application 110 and the requesting application 120 can be distributed applications hosted by different servers connected across a network.

Once generated, the simulated servicing application 145 can then be used in lieu of the actual servicing application 110 within the software development environment 105. Use of the simulated servicing application 145 can be limited to situations involving the captured (or extrapolated) data 137.

As used herein, presented data stores, including store 135, can be a physical or virtual storage space configured to store digital information. Data store 135 can be physically implemented within any type of hardware including, but not limited to, a magnetic disk, an optical disk, a semiconductor memory, a digitally encoded plastic memory, a holographic memory, or any other recording medium. The data store 135 can be a stand-alone storage unit as well as a storage unit formed from a plurality of physical devices. Additionally, information can be stored within data store 135 in a variety of manners. For example, information can be stored within a database structure or can be stored within one or more files of a file storage system, where each file may or may not be indexed for information searching purposes. Further, data store 135 can utilize one or more encryption mechanisms to protect stored information from unauthorized access.

FIG. 2 is a schematic diagram of a simulated servicing application 200 in accordance with an embodiment of the inventive arrangements disclosed herein. The simulated servicing application 200 can be generated by system 100 (by the simulator generation engine 140) for a servicing application 110.

The simulated servicing application 200 can include a set of data maps 205 and a set of interface stubs 210. The set of data maps 205 can contain information that relates input data 220 that the simulated servicing application 200 can expect to receive with output data 225 that the simulated servicing application 200 can be expected to return in response. The set of data maps 205 can be constructed by the simulator generation engine from captured interaction data or from data derived from captured interaction data.

Table 215 contains example input 220 and output 225 data. It should be noted that the entries in table 215 are for illustrative purposes only and are not meant as a definitive implementation. The input data 220 can correspond to message data received by the servicing application, such as the function request 125 of system 100. Additionally, input parameters 230 of a received message are stored with the corresponding input data 220.

The output data 225 can represent message data (or a null) to be returned to a requester for a corresponding input 220. As shown in this example, the simulated servicing application 200 should return a value of “1” to a requester who requests “getService (email)”.

The set of interface stubs 210 can represent a set of software code blocks to handle the simulated interactions. Each item set of interface stubs 210 can represent a standardized software code block to handle a single type of interaction. For example, a Web services interface stub can handle interactions that utilize Web communication protocols, whereas a post office protocol (POP) interface stub can handle email interactions. The set of interface stubs 210 included within the simulated servicing application 200 can be selected by the simulator generation engine based on the type of interactions that the simulated servicing application 200 needs to support. Filtering and information isolation techniques can be used when selecting the set of interface stubs 210.

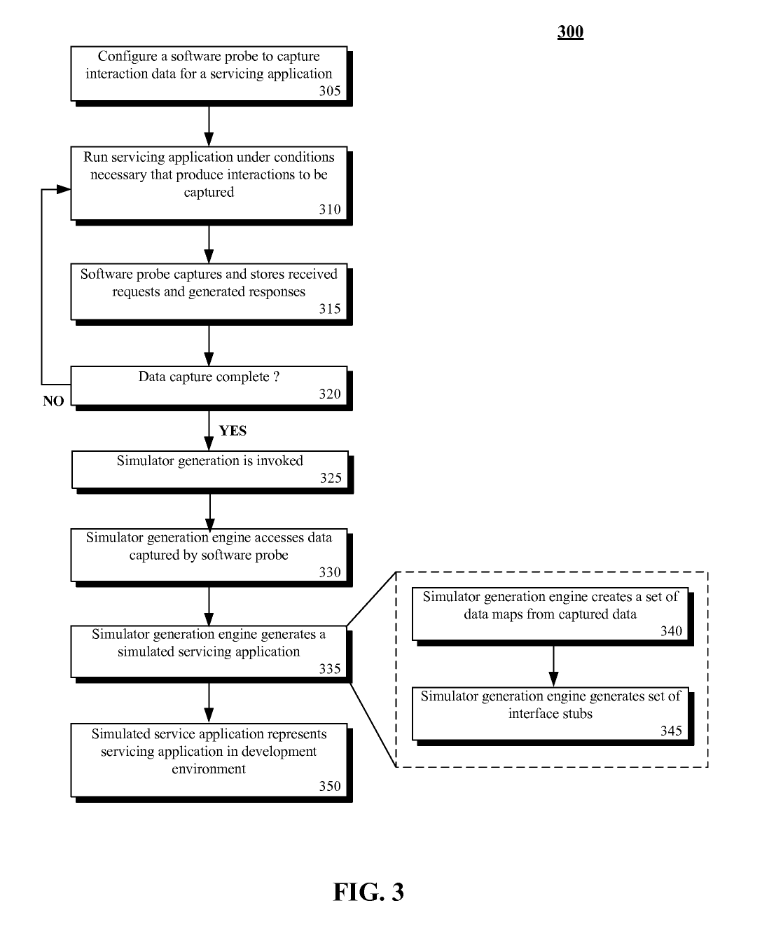

FIG. 3 is a flow chart of a method 300 for creating a simulated servicing application from data captured by a configurable software probe in accordance with an embodiment of the inventive arrangements disclosed herein. Method 300 can be performed in the context of system 100 of FIG. 1 and/or utilize the simulated servicing application 200 of FIG. 2.

Method 300 can begin with step 305 where a software probe can be configured to capture interaction data for a servicing application. In step 310, the servicing application can be run under conditions that are necessary to produce the interactions for capturing. That is, if the software probe is configured to capture Web interactions, then the servicing application should be run under conditions that generate Web interactions.

The software probe can then capture and store the received requests and generated responses of the servicing application in step 315. In step 320, it can be determined if the data capture is complete. Completion of the data capture can be predetermined by system operators prior to or during execution of method 300.

When the data capture is incomplete, flow can return to step 310 where the servicing application can continue to run and the software probe can continue to capture data. When the data capture is complete, step 325 can execute where the simulator generation engine can be invoked.

In step 330, the simulator generation engine can access the data captured by the software probe. “Captured data” is herein used in a broad sense to include directly captured data, processed (sanitized) data, heuristically derived data (from a captured set of data), and manually entered data (based on a captured set of data). The simulator generation engine can generate a simulated servicing application in step 335. Generation of the simulated servicing application in step 335 can be achieved via steps 340 and 345.

The simulator generation engine can create the set of data maps from the captured data in step 340. In step 345, the simulator generation engine can generate the set of interface stubs.

Once the simulated servicing application is generated, step 350 can execute where the simulated servicing application can be used in a development environment to represent interactions with the servicing application.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A system for creating a simulated service application from data captured by a configurable software probe comprising:
a servicing application configured to provide at least one function to a requesting application;
a configurable software probe designed to dynamically capture a plurality of function requests and a plurality of return data corresponding to the plurality of function requests; and
a simulator generation engine configured to generate a simulated servicing application that simulates a functioning of the servicing application, wherein generation of the simulated servicing application utilizes the plurality of function requests and return data captured by the configurable software probe.

2. The system of claim 1, wherein the configurable software probe is embedded within the servicing application, and wherein the simulated servicing application generated by the simulator generation engine further comprises:
a set of data maps configured to contain correlations between the plurality of captured function requests and the plurality of captured corresponding return data; and
a set of interface stubs representing expected communication paths, wherein each interface stub in said set utilizes at least one data map in the set of data maps to simulate the at least one function of the servicing application.

3. The system of claim 1, wherein a function request captured by the configurable software probe includes a set of input parameters, wherein the set of input parameters is expected by a function for execution.

4. The system of claim 3, wherein the set of input parameters is captured and stored with its corresponding function request by the configurable software probe.

5. The system of claim 1, wherein the configurable software probe is a dynamic probe utilizing Byte Code Instrumentation (BCI), wherein a set of machine-readable instructions is interjected into the servicing application at runtime, wherein the set of machine-readable instructions is executed concurrently with the servicing application.

6. The system of claim 1, wherein the configurable software probe allows for user-customization of data for capture.

7. The system of claim 1, wherein the configurable software probe is a static probe, wherein a set of machine-readable instructions is incorporated into a set of base code for the servicing application and compiled with the set of base code prior to runtime.

8. The system of claim 1, wherein the components of claim 1 operate in a software development environment.

9. A method for creating a simulated service application from data captured by a configurable software probe comprising:
configuring a software probe to capture a set of input and output interactions for a servicing application;
operating the servicing application in a software development environment;
the software probe capturing the set of input and output interactions;
invoking a simulator generation engine; and
the simulator generation engine generating a simulated servicing application from the captured user-selected input and output data.

10. The method of claim 9, wherein the generating step further comprises:
the simulator generation engine synthesizing the captured set of input and output interactions into at least one data map; and
the simulator generation engine creating a set of interface stubs, wherein each interface stub represents an expected communication path for the servicing application.

11. The method of claim 10, wherein the simulated servicing application utilizes the synthesized data maps and the set of interface stubs to simulate an operation of the servicing application.

12. The method of claim 9, wherein the set of input and output interactions contains at least one function request sent by a client application to the servicing application and at least one return data generated by the servicing application that corresponds to the at least one function request.

13. The method of claim 12, wherein the at least one function request contains a set of input parameters, wherein the set of input parameters is expected by the servicing application for operation.

14. The method of claim 9, wherein the software probe is a dynamic probe utilizing Byte Code Instrumentation (BCI), wherein a set of machine-readable instructions is interjected into the servicing application at runtime, wherein the set of machine-readable instructions is executed concurrently with the servicing application.

15. The method of claim 9, wherein the software probe is a static probe, wherein a set of machine-readable instructions is incorporated into a set of base code for the servicing application and compiled with the set of base code prior to runtime.

16. The method of claim 9, wherein said steps of claim 9 are performed by at least one machine in accordance with at least one computer program stored in a computer readable media, said computer programming having a plurality of code sections that are executable by the at least one machine.

17. A simulated servicing application comprising:
a set of data maps containing correlations between at least one function request and at least one return data corresponding to the at least one function request for a servicing application; and
a set of interface stubs representing expected communication paths, wherein each interface stub in said set utilizes at least one data map in the set of data maps to simulate at least one function of the servicing application.

18. The simulated servicing application of claim 17, wherein the at least one function request contains a set of input parameters, wherein the set of input parameters is expected by the servicing application for operation.

19. The simulated servicing application of claim 17, wherein the at least one function request and the at least one corresponding return data are captured by a configurable software probe embedded within the servicing application.

20. The simulated servicing application of claim 19, wherein the configurable software probe is a dynamic probe utilizing Byte Code Instrumentation (BCI), wherein a set of machine-readable instructions is interjected into the servicing application at runtime, wherein the set of machine-readable instructions is executed concurrently with the servicing application.
